(19) United States
(12) Patent Application Publication
(10) Pub. No.: US 2014/0022107 A1
(43) Pub. Date: Jan. 23, 2014

(54) METHOD AND APPARATUS FOR MANAGING TRACKING INFORMATION USING UNIQUE ID IN VESSEL TRAFFIC SYSTEM

(71) Applicant: Electronics and Telecommunications Research Institute, Daejeon (KR)

(72) Inventors: Byung-Doo KIM, Daejeon (KR); Do-Hyeung KIM, Daejeon (KR); Joong-Yong CHOI, Uijeongbu (KR); Byung-Gil LEE, Daejeon (KR)

(21) Appl. No.: 13/940,189

(22) Filed: Jul. 11, 2013

(30) Foreign Application Priority Data
Jul. 17, 2012 (KR) 10-2012-0077965
Apr. 2, 2013 (KR) 10-2013-0035560

(51) Int. Cl. G08G 3/00; G01S 13/91

(52) U.S. Cl. CPC G08G 3/00; G01S 13/91
USPC 342/41

(57) ABSTRACT

Disclosed herein are a method and apparatus for managing tracking information using a unique ID in a Vessel Traffic System (VTS). In the method, a multi-sensor integration system issues a unique ID corresponding to a target, and sends a tracking command including the unique ID to radar tracking systems. The multi-sensor integration system receives first tracking information reports corresponding to the unique ID from the radar tracking systems. The multi-sensor integration system generates a second tracking information report by integrating the first tracking information reports using the unique ID. The multi-sensor integration system sends the second tracking information report to a system administrator so that information about tracking of the target is provided to the system administrator.

### CROSS REFERENCE TO RELATED APPLICATIONS

This application claims the benefit of Korean Patent Application Nos. 10-2012-0077965 and 10-2013-0035560, respectively filed on Jul. 17, 2012 and Apr. 2, 2013, which are hereby incorporated by reference in their entirety into this application.

### BACKGROUND OF THE INVENTION

1. Technical Field

The present invention relates generally to a Vessel Traffic System (VTS) using a plurality of radar tracking systems and an Automatic Identification System (AIS) and, more particularly, to technology that can track a target using radar tracking systems based on a unique ID, process information about the tracking of the target provided by the radar tracking systems and target information collected by the AIS in an integrated manner, and display the results of the processing on a control screen.

2. Description of the Related Art

A VTS collects the tracking information (e.g., location and speed) and status information of vessels using various types of sensors including radars so as to support the safe navigation of vessels, and provides various services, such as the wake monitoring of a vessel and guidance to a safe route, using the collected tracking information and status information.

The VTS includes a plurality of radar tracking systems and an AIS. For convenience of control, a plurality of pieces of vessel traffic information collected in various environments should be transferred to a traffic controller in the form of integrated information for each target.

In general, a method is used in which a plurality of radar tracking systems included in a VTS assigns respective IDs to a target and tracks the target, and then a unified ID is assigned to the target during the process of integrating a plurality of pieces of tracking information, thereby managing a plurality of pieces of information regarding the same target in an integrated manner.

In order to integrate various pieces of tracking information that are collected by a plurality of radar tracking systems and an AIS for each target, a correlation between the pieces of tracking information is calculated. If the calculated correlation satisfies a predetermined threshold condition, corresponding targets are determined to be the same target, and the pieces of tracking information are integrated with each other.

A method of calculating correlations between pieces of tracking information and integrating the pieces of tracking information as described above is problematic in that excessive time and money are required because hardware is excessively complicated and in that the computational load required to calculate correlations between pieces of tracking information suddenly increases when the amount of tracking information increases.

Korean Patent Application Publication Nos. 10-2010-0013099 and 10-2012-0063769 disclose a vessel control system and a vessel control apparatus using surveillance radars. In these publications, a complicated process, such as correlation calculation, is required to integrate pieces of tracking information collected by radar tracking systems and an AIS because the radar tracking systems and the AIS assign respective IDs to a vessel.

Accordingly, there is an urgent need for new technology in which radar tracking systems and an AIS can share a unique ID assigned to each target and thus a plurality of pieces of vessel tracking information can be effectively integrated.

### SUMMARY OF THE INVENTION

Accordingly, the present invention has been made keeping in mind the above problems occurring in the prior art, and an object of the present invention is to effectively integrate a plurality of pieces of tracking information provided by radar tracking systems and an AIS without requiring a complicated process, such as correlation calculation, because a multi-sensor integration system that manages the radar tracking systems and the AIS in an integrated manner manages a unique ID assigned to each target in an integrated manner.

Another object of the present invention is to automatically generate a unique ID corresponding to a boundary area or AIS target information from an AIS so that radar tracking systems can efficiently make reports based on the unique ID in the multi-sensor integration system that manages the radar tracking systems and the AIS in an integrated manner.

In accordance with an aspect of the present invention, there is provided a method of managing tracking information using a unique ID in a Vessel Traffic System (VTS), the method including issuing, by a multi-sensor integration system, a unique ID corresponding to a target, and sending, by a multi-sensor integration system, a tracking command including the unique ID to radar tracking systems; receiving, by the multi-sensor integration system, first tracking information reports corresponding to the unique ID from the radar tracking systems; generating, by the multi-sensor integration system, a second tracking information report by integrating the first tracking information reports using the unique ID; and sending, by the multi-sensor integration system, the second tracking information report to a system administrator so that information about tracking of the target is provided to the system administrator.

Each of the first tracking information reports may include a pair of a unique ID corresponding to one or more targets and tracking information corresponding to the one or more targets.

The method may further include sending, by the multi-sensor integration system, a boundary area setting command to the radar tracking systems; and receiving, by the multi-sensor integration system, a unique ID issuance request corresponding to the boundary area setting command from the radar tracking systems; wherein the tracking command is generated in response to the unique ID issuance request.

The unique ID issuance request may correspond to a vessel that enters a boundary area corresponding to the boundary area setting command, or departs from the boundary area.

The method may further include receiving, by the multi-sensor integration system, an Automatic Identification System (AIS) collection information report from an AIS information processing system; wherein the tracking command includes the unique ID generated in response to the AIS collection information report.

The method may further include determining, by the multi-sensor integration system, whether a target performs handover using the first tracking information reports; and sending, by the multi-sensor integration system, an automatic tracking command to a radar tracking system corresponding to the handover if the target performs handover.

The automatic tracking command may include the unique ID used prior to the handover and information about a location of the target determined prior to the handover.

The method may further include receiving, by the multi-sensor integration system, a tracking cancellation command including the unique ID; and transferring, by the multi-sensor integration system, the tracking cancellation command to the radar tracking system corresponding to the unique ID so that the radar tracking system stops tracking of the target corresponding to the unique ID.

In accordance with another aspect of the present invention, there is provided a multi-sensor integration system, including a unique ID issue unit configured to issue a unique ID corresponding to a target; a tracking command transmission unit configured to send a tracking command including the unique ID to radar tracking systems; a report reception unit configured to receive first tracking information reports corresponding to the unique ID from the radar tracking systems; a tracking information integration unit configured to generate a second tracking information report by integrating the first tracking information reports using the unique ID; and a report transmission unit configured to send the second tracking information report to a system administrator so that information about tracking of the target is provided to the system administrator.

Each of the first tracking information reports may include a pair of a unique ID corresponding to one or more targets and tracking information corresponding to the one or more targets.

The multi-sensor integration system may send a boundary area setting command to the radar tracking systems and receive a unique ID issuance request corresponding to the boundary area setting command from the radar tracking systems; and the tracking command may be generated in response to the unique ID issuance request.

The unique ID issuance request may correspond to a vessel that enters a boundary area corresponding to the boundary area setting command, or departs from the boundary area.

The multi-sensor integration system may receive an AIS collection information report from an AIS information processing system; and the tracking command may include the unique ID generated in response to the AIS collection information report.

The multi-sensor integration system may determine whether a target performs handover using the first tracking information reports, and send an automatic tracking command to a radar tracking system corresponding to the handover if the target performs handover.

The automatic tracking command may include the unique ID used prior to the handover and information about a location of the target determined prior to the handover.

The multi-sensor integration system may receive a tracking cancellation command including the unique ID, and transfer the tracking cancellation command to a radar tracking system corresponding to the unique ID so that the radar tracking system stops tracking of the target corresponding to the unique ID.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a VTS according to an embodiment of the present invention;

FIG. 2A is a diagram showing an example of processing manual tracking commands in a method of managing tracking information in a VTS;

FIG. 2B is a diagram showing another example of processing manual tracking commands in a method of managing tracking information in a VTS;

FIG. 3 is a diagram showing an example of processing automatic boundary area tracking commands in a method of managing tracking information in a VTS;

FIG. 4 is a diagram showing an example of processing an automatic AIS tracking command in a method of managing tracking information in a VTS;

FIG. 5 is a diagram showing the handover of the VTS using a plurality of radar tracking systems;

FIG. 6 is a diagram showing an example of processing an automatic handover tracking command in a method of managing tracking information in a VTS;

FIG. 7 is a diagram showing an example of processing tracking cancellation commands in a method of managing tracking information in a VTS; and

FIG. 8 is a block diagram showing the multi-sensor integration system of the VTS according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily vague will be omitted below. The embodiments of the present invention are intended to fully describe the present invention to a person having ordinary knowledge in the art. Accordingly, the shapes, sizes, etc. of elements in the drawings may be exaggerated to make the description clear.

Embodiments of the present invention will be described in detail below with reference to the accompanying drawings.

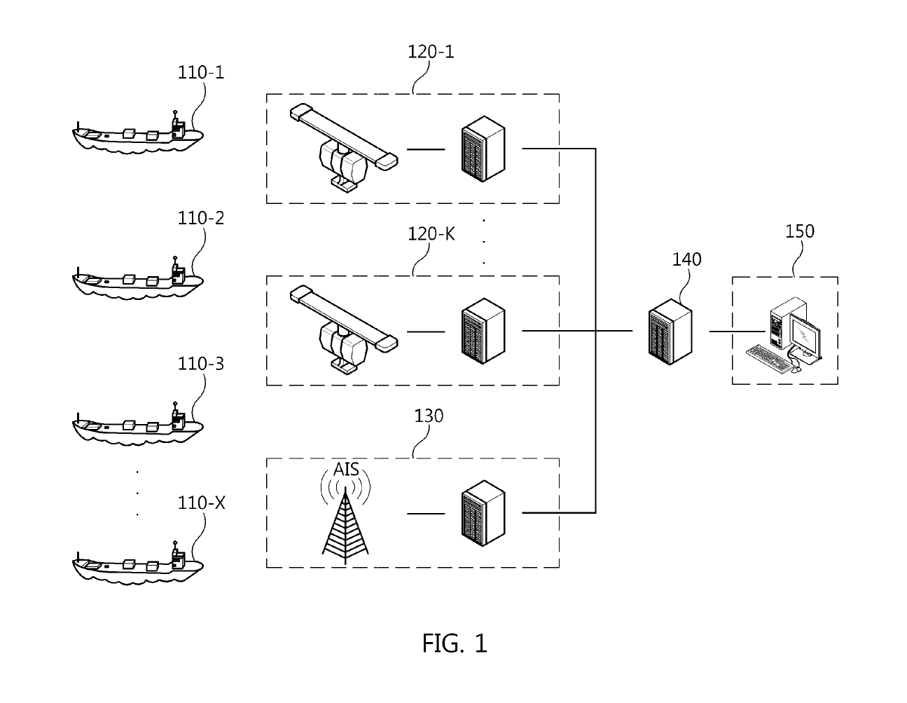

FIG. 1 is a diagram showing a VTS according to an embodiment of the present invention.

Referring to FIG. 1, the VTS includes radar tracking systems 120-1, . . . , 120-K, an AIS information processing system 130, a multi-sensor integration system 140, and a VTS operating system 150 in order to track targets 110-1, 110-2, 110-3, . . . , 110-X.

The targets 110-1, 110-2, 110-3, . . . , 110-X are objects that are controlled by the VTS. The radar tracking systems 120-1, . . . , 120-K collect information about the tracking of the targets. The AIS information processing system 130 collects information about the targets on each of which an AIS is mounted.

The multi-sensor integration system 140 effectively integrates the tracking information provided by the plurality of radar tracking systems 120-1, . . . , 120-K and the target information provided by the AIS information processing system 130, using a unique ID. The integrated track/target information is transferred to the VTS operating system 150, and displayed on a control screen.

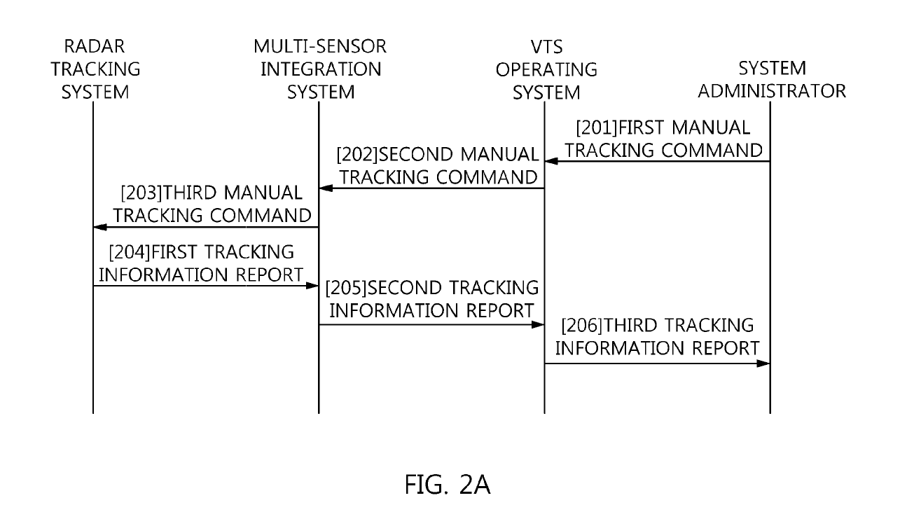

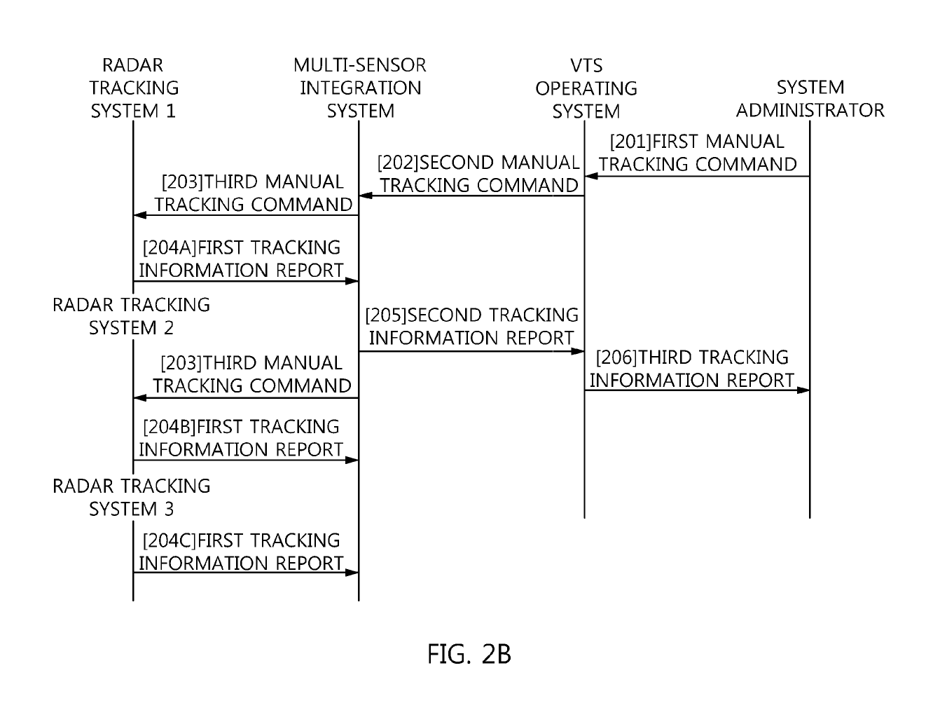

FIG. 2A is a diagram showing an example of processing manual tracking commands in a method of managing tracking information in a VTS.

Referring to FIG. 2A, the manual tracking of the VTS is performed via a first manual tracking command 201, a second manual tracking command 202, a third manual tracking command 203, a first tracking information report 204, a second tracking information report 205, and a third tracking information report 206.

The first manual tracking command 201 is issued by a system administrator through an input device, such as a mouse, a track ball, or a touch screen. The second manual tracking command 202 includes location information corresponding to the issued first manual tracking command 201, such as latitude and longitude, and is sent to the multi-sensor integration system 140.

In response to the second manual tracking command 202, the multi-sensor integration system 140 assigns a unique ID to a target and sends the third manual tracking command 203 including the unique ID and the location information to a radar tracking system that covers a corresponding area as a detection area.

In response to the third manual tracking command 203, the radar tracking system causes the target to be managed using the unique ID, and then starts the tracking of the target. The radar tracking system sends a first tracking information report 204 to the multi-sensor integration system 140 at predetermined report cycles. The first tracking information report 204 may be configured as (unique ID 1, tracking information 1), . . . , (unique ID n, tracking information n).

The multi-sensor integration system 140 integrates tracking information having the same unique ID and processes tracking information having independent and unique IDs, the tracking information being selected from among the tracking information provided by a plurality of the radar tracking systems, and sends the results to the VTS operating system 150 via a second tracking information report 205. The second tracking information report 205 may be configured as (unique ID 1, tracking information 1), . . . , (unique ID m, tracking information m).

The VTS operating system 150 processes a third tracking information report 206 by displaying information about the second tracking information report 205 on the VTS operating screen of the system administrator.

FIG. 2B is a diagram showing another example of processing manual tracking commands in the method of managing tracking information in a VTS.

Referring to FIG. 2B, the manual tracking of the VTS is performed via a first manual tracking command 201, a second manual tracking command 202, a third manual tracking command 203, a first tracking information report 204, a second tracking information report 205, and a third tracking information report 206.

In particular, from the example of FIG. 2B, it can be seen that a radar tracking system 1, a radar tracking system 2, and a radar tracking system 3 send respective first tracking information reports 204a, 204b, and 204c at predetermined report cycles in response to the third manual tracking command 203 of the multi-sensor integration system 140.

The multi-sensor integration system 140 receives the first tracking information reports 204a, 204b, and 204c from the radar tracking system 1, the radar tracking system 2, and the radar tracking system 3, integrates a plurality of pieces of tracking information about the same target using a unique ID, generates the second tracking information report 205, and sends the generated second tracking information report 205 to the VTS operating system 150.

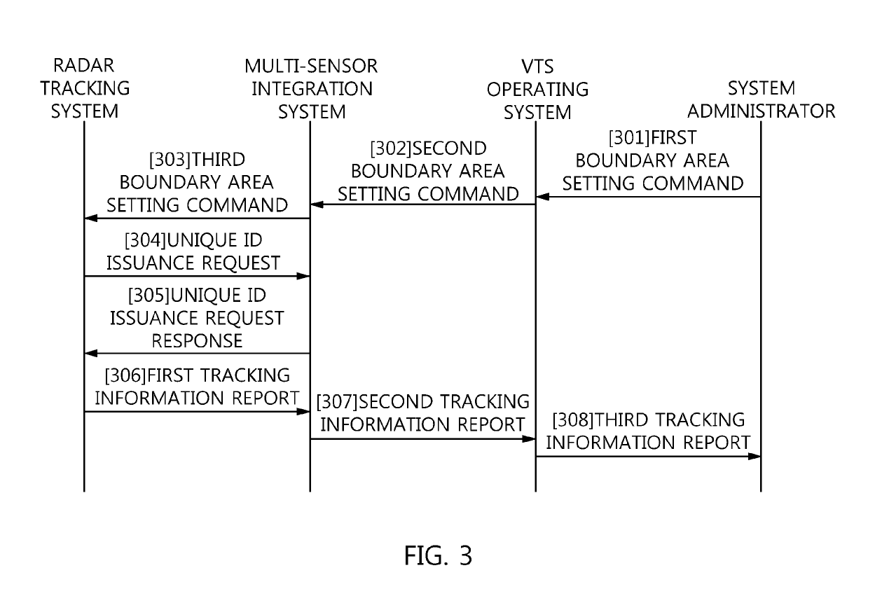

FIG. 3 is a diagram showing an example of processing automatic boundary area tracking commands in the method of managing tracking information in a VTS.

Referring to FIG. 3, the automatic boundary area tracking of the VTS is performed via a first boundary area setting command 301, a second boundary area setting command 302, a third boundary area setting command 303, a unique ID issuance request 304, a unique ID issuance request response 305, a first tracking information report 306, a second tracking information report 307, and a third tracking information report 308.

The first boundary area setting command 301 is applied by a system administrator through an input device, such as a mouse, a track ball, or a touch screen. The second boundary area setting command 302 is converted into the third boundary area setting command 303 including a plurality of pieces of location information (latitude 1, longitude 1), . . . , (latitude n, longitude n) representing a boundary area corresponding to the applied first boundary area setting command, and is then transmitted to the multi-sensor integration system 140. The multi-sensor integration system 140 sends the third boundary area setting command 303 to a radar tracking system that covers a corresponding area as a detection area based on the second boundary area setting command 202.

The radar tracking system sends the unique ID issuance request 304 to the multi-sensor integration system 140 regarding a new target, such as a vessel that enters or departs from a boundary area set by the third boundary area setting command 303. In response to the unique ID issuance request 304, the multi-sensor integration system 140 issues a new unique ID to the new target, and sends the unique ID issuance request response 305 including the issued unique ID to the radar tracking system.

The radar tracking system causes the new target to be managed using the unique ID issued by the multi-sensor integration system 140, and then starts the tracking of the new target. The radar tracking system sends the first tracking information report 306 to the multi-sensor integration system 140 at predetermined report cycles. The first tracking information report may be configured as (unique ID 1, tracking information 1), . . . , (unique ID n, tracking information n).

The multi-sensor integration system 140 combines tracking information having the same unique ID and processes tracking information having independent and unique IDs, the tracking information being selected from among pieces of tracking information provided by a plurality of the radar tracking systems, and sends the results to the VTS operating system 150 via the second tracking information report 307. The second tracking information report 307 may be configured as (unique ID 1, tracking information 1), . . . , (unique ID m, tracking information m). The VTS operating system processes the third tracking information report 308 by displaying information about the second tracking information report 307 on the VTS operating screen of the system administrator.

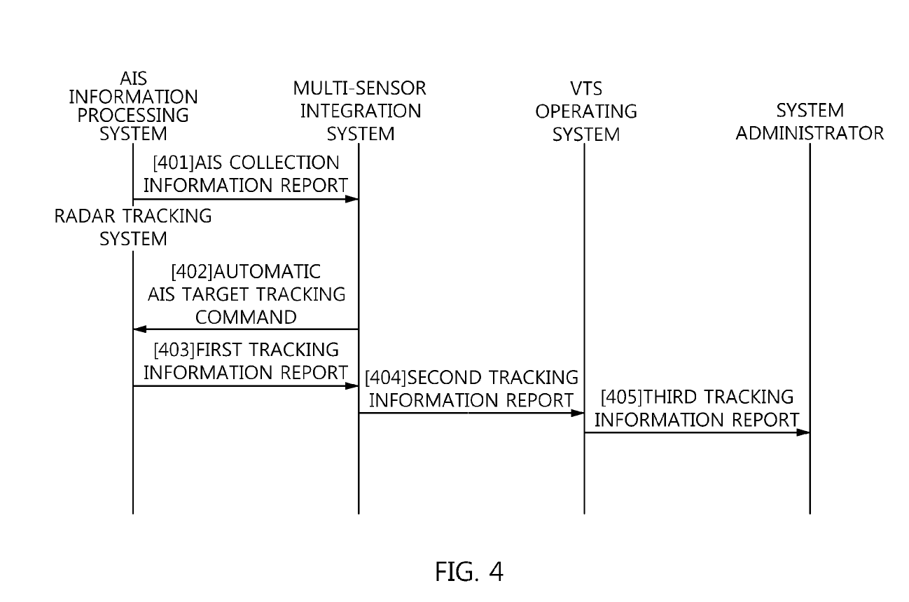

FIG. 4 is a diagram showing an example of processing an automatic AIS tracking command in the method of managing tracking information in a VTS.

Referring to FIG. 4, the AIS-automatic tracking of the VTS is performed via an AIS collection information report 401, an automatic AIS target tracking command 402, a first tracking information report 403, a second tracking information report 404, and a third tracking information report 405.

AIS target information collected by the AIS information processing system 130 is sent to the multi-sensor integration system 140 via the AIS collection information report 401. The AIS collection information report 401 may include an MMSI and information about the location of a corresponding vessel, such as latitude and longitude.

The multi-sensor integration system 140 assigns a new unique ID to new AIS target information regarding a new target, and sends the automatic AIS target tracking command 402 including the new AIS target information to a radar tracking system. The radar tracking system causes the new target to be managed based on the new unique ID issued by the multi-sensor integration system 140, and then starts the tracking of the new target based on the automatic AIS target tracking command 402 so that. The radar tracking system sends the first tracking information report 403 to the multi-sensor integration system 140 at predetermined report cycles. The first tracking information report 403 may be configured as (unique ID 1, tracking information 1), . . . , (unique ID n, tracking information n). The multi-sensor integration system 140 integrates a plurality of pieces of tracking information having the same unique ID and processes pieces of tracking information having independent and unique IDs, the tracking information being selected from among pieces of tracking information provided by a plurality of the radar tracking systems, and sends the results to the VTS operating system 150 via the second tracking information report 404.

The second tracking information report 404 may be configured as (unique ID 1, tracking information 1), . . . , (unique ID m, tracking information m). The VTS operating system 150 processes the third tracking information report 405 by displaying information about the second tracking information report 404 on the VTS operating screen of the system administrator.

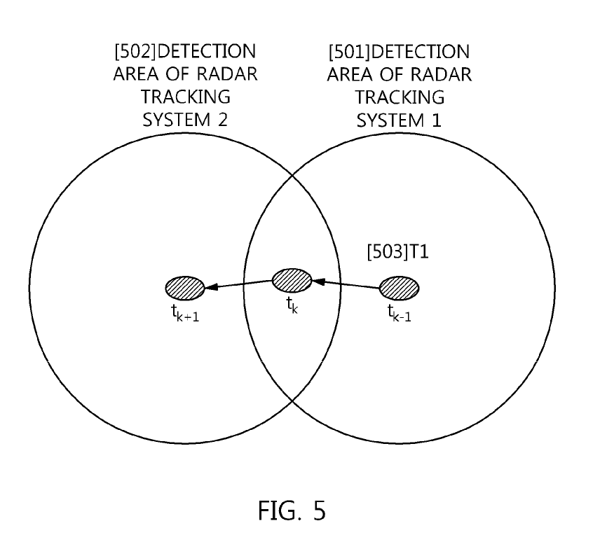

FIG. 5 is a diagram showing the handover of the VTS using a plurality of radar tracking systems.

From FIG. 5, it can be seen that handover occurs as a target T1 503 being tracked in the detection area 501 of a radar tracking system 1 moves to the detection area 502 of a radar tracking system 2. The target T1 503 was being tracked in the detection area 501 of the radar tracking system 1 at a point of time tₖ₋₁, but the target T1 503 enters a common area where the detection area 501 of the radar tracking system 1 crosses the detection area 502 of the radar tracking system 2 at a point of time Tₖ and enters an area included only in the detection area 502 of the radar tracking system 2 at a point of time tₖ₊₁, thereby generating handover.

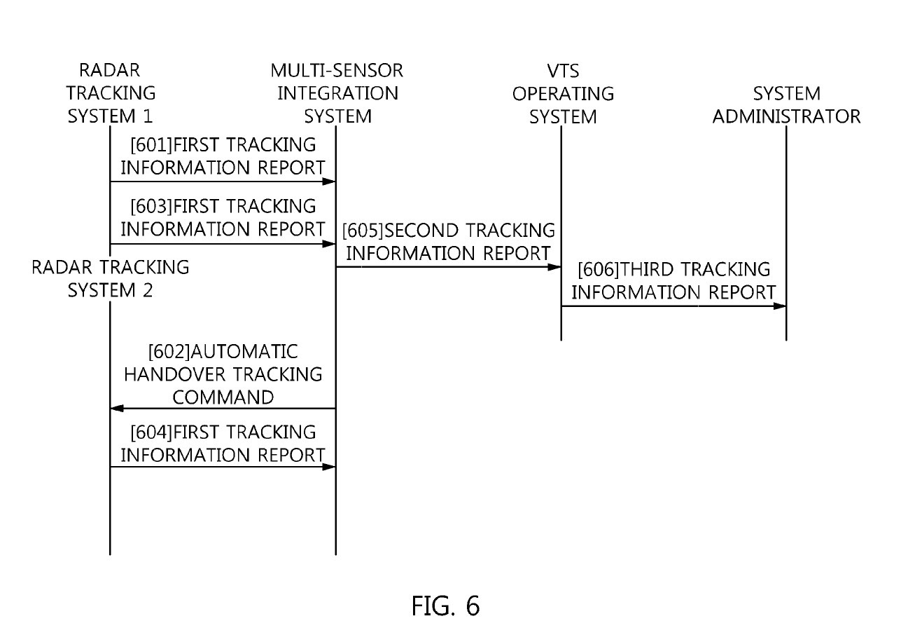

FIG. 6 is a diagram showing an example of processing an automatic handover tracking command in the method of managing tracking information in a VTS.

Referring to FIG. 6, the handover track of the VTS is performed via a first tracking information report 601, an automatic handover tracking command 602, first tracking information reports 603 and 604, a second tracking information report 605, and a third tracking information report 606.

The first tracking information report 601 provided by a radar tracking system 1 may include unique IDs and a plurality of pieces of tracking information regarding targets included in the detection area of the radar tracking system 1. The first tracking information report 601 may be configured as (unique ID 1, tracking information 1), . . . , (unique ID n, tracking information n). The multi-sensor integration system 140 determines whether a target is handed over to a radar tracking system 2 based on the first tracking information report 601 provided by the radar tracking system 1, and sends the automatic handover tracking command 602 to the radar tracking system 2 in relation to the handover target. The automatic handover tracking command 602 may include the unique ID managed by the radar tracking system 1 and information about the location of the handover target, such as latitude and longitude.

In response to the automatic handover tracking command 602, the radar tracking system 2 causes the handover target to be managed using the unique ID managed by the radar tracking system 1, and then starts the tracking of the handover target.

The radar tracking system 1 and the radar tracking system 2 send the respective first tracking information reports 603 and 604 to the multi-sensor integration system 140 at predetermined report cycles.

The first tracking information report 603 may be configured as (unique ID 1, tracking information 1), . . . , (unique ID i, tracking information i), and the first tracking information report 604 may be configured as (unique ID 1, tracking information 1), . . . , (unique ID j, tracking information j). Here, natural numbers i and j may be determined by the number of targets being tracked.

The multi-sensor integration system 140 integrates a plurality of pieces of tracking information having the same unique ID and processes pieces of tracking information having an independent and unique ID, the tracking information being selected from among pieces of tracking information provided by a plurality of the radar tracking systems, and sends the results to the VTS operating system 150 via the second tracking information report 605.

The second tracking information report 605 may be configured as (unique ID 1, tracking information 1), . . . , (unique ID m, tracking information m).

The VTS operating system 150 processes the third tracking information report 606 by displaying information about the second tracking information report 605 on the VTS operating screen of a system administrator.

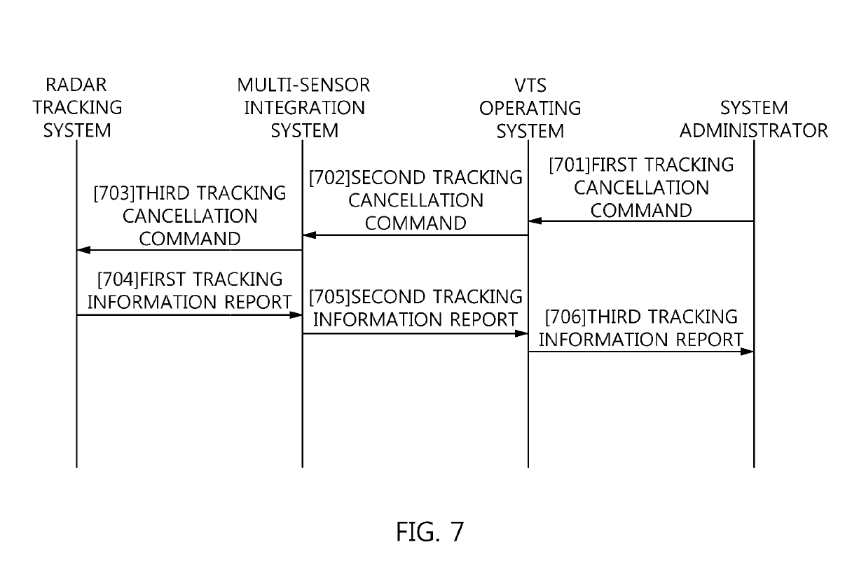

FIG. 7 is a diagram showing an example of processing tracking cancellation commands in the method of managing tracking information in a VTS.

Referring to FIG. 7, the tracking cancellation of the VTS is performed via a first tracking cancellation command 701, a second tracking cancellation command 702, a third tracking cancellation command 703, a first tracking information report 704, a second tracking information report 705, and a third tracking information report 706.

The first tracking cancellation command 701 is applied by a system administrator through an input device, such as a mouse, a track ball, or a touch screen. The second tracking cancellation command 702 includes the unique ID of a target corresponding to the first manual tracking command 701. The second tracking cancellation command 702 is transmitted to the multi-sensor integration system 140.

In response to the second tracking cancellation command 702, the multi-sensor integration system 140 generates the third tracking cancellation command 703 including the unique ID of the target, and sends the generated third tracking cancellation command 703 to a radar tracking system that covers a corresponding area as a detection area.

In response to the third tracking cancellation command 703, the radar tracking system deletes tracking information having a unique ID identical to that included in the third tracking cancellation command 703.

The radar tracking system sends the first tracking information report 704 to the multi-sensor integration system 140 at predetermined report cycles. The first tracking information report 704 may be configured as (unique ID 1, tracking information 1), . . . , (unique ID n, tracking information n).

The multi-sensor integration system integrates a plurality of pieces of tracking information having the same unique ID and processes pieces of tracking information having an independent and unique ID, the tracking information being selected from among a plurality of pieces of tracking information provided by a plurality of the radar tracking systems, and sends the results to the VTS operating system 150 through the second tracking information report 705.

The second tracking information report 705 may be configured as (unique ID 1, tracking information 1), . . . , (unique ID m, tracking information m). The VTS operating system 150 processes the third tracking information report 706 by displaying information about the second tracking information report 705 on the VTS operating screen of the system administrator.

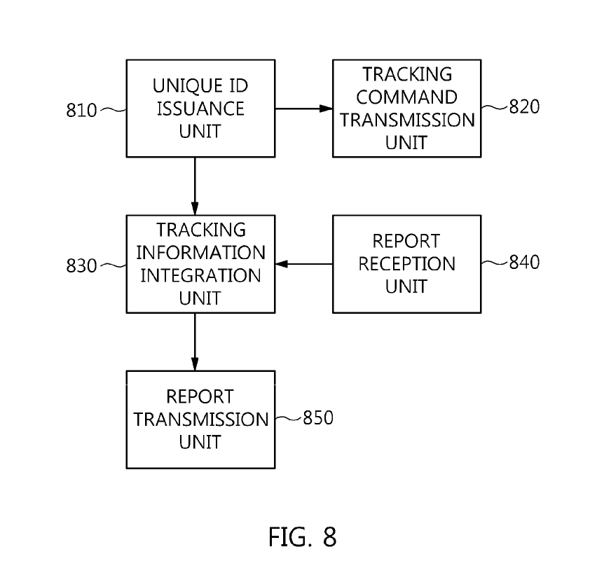

FIG. 8 is a block diagram showing the multi-sensor integration system 140 of the VTS according to an embodiment of the present invention.

Referring to FIG. 8, the multi-sensor integration system of the VTS according to an embodiment of the present invention includes a unique ID issue unit 810, a tracking command transmission unit 820, a tracking information integration unit 830, a report reception unit 840, and a report transmission unit 850.

The unique ID issue unit 810 issues a unique ID to a target.

The tracking command transmission unit 820 sends a tracking command including the unique ID to the radar tracking systems 120-1, . . . , 120-k.

The report reception unit 840 receives first tracking information reports on the unique ID from the radar tracking systems.

The tracking information integration unit 830 generates a second tracking information report by integrating the first tracking information reports based on the unique ID.

The report transmission unit 850 sends the second tracking information report to a system administrator so that information about tracking of the target is provided to the system administrator.

Here, each of the first tracking information reports may include a pair of a unique ID corresponding to one or more targets and tracking information regarding the one or more targets.

The multi-sensor integration system 140 may send a boundary area setting command to the radar tracking systems, and may receive a unique ID issuance request corresponding to the boundary area setting command from the radar tracking systems. The tracking command may be generated in response to the unique ID issuance request.

The unique ID issuance request may correspond to a vessel that enters or departs from the boundary area corresponding to the boundary area setting command.

The multi-sensor integration system 140 may receive an AIS collection information report from the AIS information processing system 130. The tracking command may include a unique ID generated in response to the AIS collection information report.

Here, the multi-sensor integration system 140 may determine whether a target performs handover using the first tracking information reports. If the target performs handover, the multi-sensor integration system 140 may send an automatic tracking command to a radar tracking system to which the target performs handover.

Here, the automatic tracking command may include the unique ID used prior to the handover and information about the location of the target determined prior to the handover.

Here, the multi-sensor integration system 140 may receive a tracking cancellation command including the unique ID, and may transfer the tracking cancellation command to the radar tracking system so that the radar tracking system corresponding to the unique ID stops the tracking of the target corresponding to the unique ID.

As described above, in accordance with the present invention, the multi-sensor integration system that manages radar tracking systems and an AIS in an integrated manner can manage a unique ID issued to each target in an integrated manner. Accordingly, a plurality of pieces of tracking information provided by the radar tracking systems and the AIS can be effectively integrated even without requiring a complicated process, such as correlation calculation.

Furthermore, the multi-sensor integration system that manages radar tracking systems and an AIS in an integrated manner automatically generates a unique ID corresponding to a boundary area or AIS target information from the AIS, and enables the radar tracking system to perform tracking and reporting based on the unique ID. Accordingly, efficient tracking and reporting can be performed.

As described above, the method of managing tracking information using a unique ID in a VTS and the multi-sensor integration system according to the present invention are not limited to the constructions and methods of the above-described embodiments. Some or all of the embodiments may be combined with each other so that the embodiments are modified in various ways.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of managing tracking information using a unique ID in a Vessel Traffic System (VTS), the method comprising:
issuing, by a multi-sensor integration system, the unique ID corresponding to a target, and sending, by the multi-sensor integration system, a tracking command including the unique ID to radar tracking systems;
receiving, by the multi-sensor integration system, first tracking information reports corresponding to the unique ID from the radar tracking systems;
generating, by the multi-sensor integration system, a second tracking information report by integrating the first tracking information reports using the unique ID; and
sending, by the multi-sensor integration system, the second tracking information report to a system administrator so that information about tracking of the target is provided to the system administrator.

2. The method of claim 1, wherein each of the first tracking information reports includes a pair of a unique ID corresponding to one or more targets and tracking information corresponding to the one or more targets.

3. The method of claim 2, further comprising:
sending, by the multi-sensor integration system, a boundary area setting command to the radar tracking systems; and
receiving, by the multi-sensor integration system, a unique ID issuance request corresponding to the boundary area setting command from the radar tracking systems;
wherein the tracking command is generated in response to the unique ID issuance request.

4. The method of claim 3, wherein the unique ID issuance request corresponds to a vessel that enters a boundary area corresponding to the boundary area setting command, or departs from the boundary area.

5. The method of claim 2, further comprising receiving, by the multi-sensor integration system, an Automatic Identification System (AIS) collection information report from an AIS information processing system;
wherein the tracking command includes the unique ID generated in response to the AIS collection information report.

6. The method of claim 2, further comprising:
determining, by the multi-sensor integration system, whether a target performs handover using the first tracking information reports; and
sending, by the multi-sensor integration system, an automatic tracking command to a radar tracking system corresponding to the handover if the target performs handover.

7. The method of claim 6, wherein the automatic tracking command includes the unique ID used prior to the handover and information about a location of the target determined prior to the handover.

8. The method of claim 2, further comprising:
receiving, by the multi-sensor integration system, a tracking cancellation command including the unique ID; and
transferring, by the multi-sensor integration system, the tracking cancellation command to the radar tracking system corresponding to the unique ID so that the radar tracking system stops tracking of the target corresponding to the unique ID.

9. A multi-sensor integration system, comprising:
a unique ID issue unit configured to issue a unique ID corresponding to a target;
a tracking command transmission unit configured to send a tracking command including the unique ID to radar tracking systems;
a report reception unit configured to receive first tracking information reports corresponding to the unique ID from the radar tracking systems;
a tracking information integration unit configured to generate a second tracking information report by integrating the first tracking information reports using the unique ID; and
a report transmission unit configured to send the second tracking information report to a system administrator so that information about tracking of the target is provided to the system administrator.

10. The multi-sensor integration system of claim 9, wherein each of the first tracking information reports includes a pair of a unique ID corresponding to one or more targets and tracking information corresponding to the one or more targets.

11. The multi-sensor integration system of claim 10, wherein:
the multi-sensor integration system sends a boundary area setting command to the radar tracking systems and receives a unique ID issuance request corresponding to the boundary area setting command from the radar tracking systems; and
the tracking command is generated in response to the unique ID issuance request.

12. The multi-sensor integration system of claim 11, wherein the unique ID issuance request corresponds to a vessel that enters a boundary area corresponding to the boundary area setting command, or departs from the boundary area.

13. The multi-sensor integration system of claim 10, wherein:
the multi-sensor integration system receives an AIS collection information report from an AIS information processing system; and
the tracking command includes the unique ID generated in response to the AIS collection information report.

14. The multi-sensor integration system of claim 10, wherein the multi-sensor integration system determines whether a target performs handover using the first tracking information reports, and sends an automatic tracking command to a radar tracking system corresponding to the handover if the target performs handover.

15. The multi-sensor integration system of claim 14, wherein the automatic tracking command includes the unique ID used prior to the handover and information about a location of the target determined prior to the handover.

16. The multi-sensor integration system of claim 10, wherein the multi-sensor integration system receives a tracking cancellation command including the unique ID, and transfers the tracking cancellation command to a radar tracking system corresponding to the unique ID so that the radar tracking system stops tracking of the target corresponding to the unique ID.
